(19) United States
(12) Patent Application Publication
(10) Pub. No.: US 2006/0043213 A1
(43) Pub. Date: Mar. 2, 2006

(54) Fuel injection valve

(76) Inventors: Thomas Gerschwitz, Eberdingen (DE); Klaus Noller, Oppenweiler (DE); Fevzi Yildirim, Gerlingen (DE)

Correspondence Address: KENYON & KENYON, ONE BROADWAY, NEW YORK, NY, 10004, US

(21) Appl. No.: 10/540,225

(22) PCT Filed: Jan. 26, 2004
(86) PCT No.: PCT/DE04/00112

§ 371 Date: Jun. 21, 2005

(30) Foreign Application Priority Data
Mar. 11, 2003 (DE) 10310499.2

(51) Int. Cl. B05B 1/08

(52) U.S. Cl. 239/102.2

(57) ABSTRACT

A fuel injector has a piezoelectric, electrostrictive or magnetostrictive actuator, a valve needle, which is in operative connection with the actuator and acted upon with a restoring force by a valve spring in a closing direction to actuate a valve-closure member; and an hydraulic coupler which encompasses a piston that at least partially engages in a receiving opening and forms a coupler gap therewith, which is filled with an hydraulic fluid; a cavity being formed in the piston, which is open toward the coupler gap and at least partially filled with the hydraulic fluid and forms a compensating chamber.

### BACKGROUND INFORMATION

German Patent Application No. DE 35 33 085, for instance, describes a fuel injector having a piezoelectric actuator which is in operative connection with a valve needle and in doing so is braced via an hydraulic coupler. The hydraulic coupler includes a damping piston which engages in a blind hole in an upper valve portion. A gap formed between damping piston and blind hole is filled with hydraulic fluid. An annular diaphragm encloses a free end and forms a compensating chamber filled with hydraulic fluid.

Due to mechanical, thermal and electrical loading, the piezoactuator is subject to linear variation. The linear variation of the piezoactuator caused by electrical triggering is selectively utilized to produce the valve lift.

During the injection phase, the hydraulic coupler loses hydraulic fluid via the leakage gap between blind hole and damping piston. This results in a lift loss at the valve needle. During normal operation, the piezoactuator is triggered for maximally 2 ms. For this case the coupler gap is configured such that the leakage losses are minimized on the one hand, and the damping piston is repositioned again during the filling phase on the other hand.

Basic problems arise in certain operating states such as cold start, hot start, operation under emergency conditions, and at low system pressure. In a cold start, at very low temperatures (−30 degrees Celsius) and pressures (0.5 Mpa), for instance, the fuel injector must meter up to the 12-fold value of the full-load quantity. This results in long trigger times for the piezoactuator, so that the leakage loss of the hydraulic coupler becomes so large that the valve needle drops into the valve seat and ends the injection prematurely.

### SUMMARY OF THE INVENTION

The fuel injector according to the present invention has the advantage that the hydraulic coupler already returns to its original position after a brief injection pause, the coupler gap refilling with hydraulic fluid in the process. The formation of a compensating chamber within the coupler filled at least partially with hydraulic fluid ensures an effective load compensation and a reliable filling of the coupler gap.

Providing a throttle opening between the compensating chamber and the coupler gap makes it possible to reduce leakage losses during the injection phase.

The use of an elastic diaphragm to delimit the compensating chamber has the advantage that thermal and mechanical loading in the form of pressure or volume differences acting on the hydraulic fluid are compensated by the diaphragm. The diaphragm may advantageously be formed by a corrugated tube.

In a further development of the fuel injector, the hydraulic fluid in the compensating chamber is acted upon by a compensating piston. In this way, the hydraulic fluid of the compensating chamber is able to be kept under a largely constant pressure.

In an especially advantageous manner the pressure piston is configured as a differential piston at which a fuel pressure is present. This makes it possible to compensate for fluctuations in the system pressure.

### BRIEF DESCRIPTION OF THE DRAWINGS

FIG. 1 shows a schematic sectional view of a first exemplary embodiment of a fuel injector according to the present invention.

FIG. 2 shows a schematic sectional view of a second exemplary embodiment of a fuel injector according to the present invention.

FIG. 3 shows a schematic sectional view of a third exemplary embodiment of a fuel injector according to the present invention.

FIG. 4 shows an advantageous further development of the fuel injector of the present invention according to FIG. 3.

### DETAILED DESCRIPTION

In the following, exemplary embodiments of the present invention will be described by way of example. Identical parts have been provided with matching reference numerals in all of the figures.

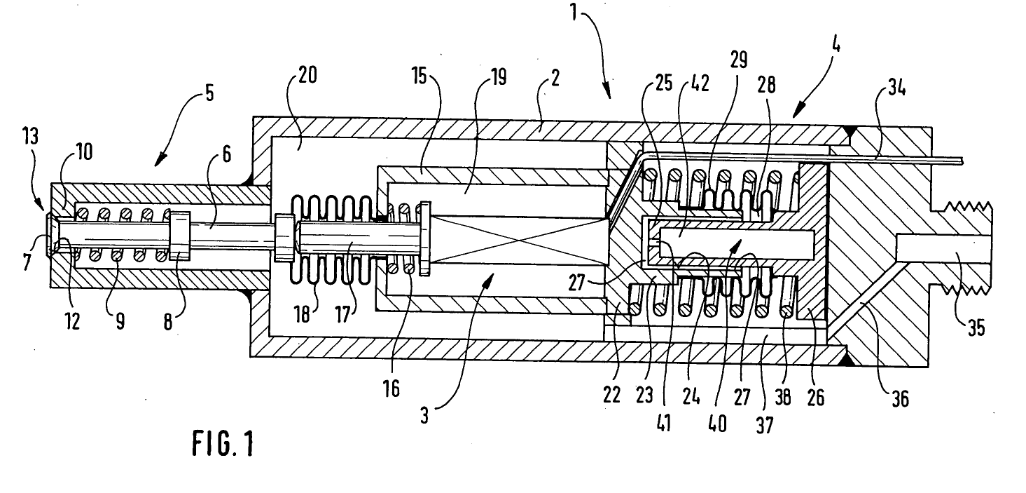

A fuel injector 1 according to the present invention shown in FIG. 1 in a longitudinal section is used in particular for the direct injection of fuel into a combustion chamber of a mixture-compressing internal combustion engine having external ignition. Arranged in a housing 2 in a mutually coaxial manner are a piezoelectric actuator 3, an hydraulic coupler 4 and a valve unit 5.

Valve unit 5 has a valve needle 6, which carries a valve-closure member 7 at its discharge-side end. Valve-closure member 7 together with a valve-seat surface 12 forms a sealing seat 13 of valve unit 5. Valve needle 6 has a flange 8 on which a valve spring 9 is braced. On the other side, valve spring 9 rests against an inwardly projecting collar 10 of housing 2 and axially pushes valve needle 6 in the direction of a closing position of sealing seat 13.

Piezoelectric actuator 3 is encapsulated in a sleeve 15 and axially prestressed by a compression spring 16. A pin-shaped actuating element 17 is interposed between actuator 3 and valve needle 6 and transmits to valve needle 6 an axial displacement of actuator 3 to open sealing seat 13. Disposed between an actuator-side end of valve needle 6 and sleeve 15 is a diaphragm 18 in the form of a corrugated tube, which seals an actuator chamber 19, situated inside sleeve 15, from a valve interior 20 arranged between sleeve 15 and housing 2. Valve interior 20 is filled with fuel.

On the coupler side, actuator chamber 19 is delimited by an actuator head 22 at which actuator 3 is axially supported on the front end. Actuator head 22 is axially displaceable relative to housing 2. On a side of actuator head 22 facing hydraulic coupler 4, it carries a tubular extension 23 which forms a receiving opening 24 for a piston 25. Piston 25 is formed as cylindrical projection on coupler head 26 and partially engages in receiving opening 24.

A coupler gap 27 is formed in receiving opening 24 between actuator head 22 and piston 25, both in the axial and the radial direction, the coupler gap being filled with an hydraulic fluid. Coupler gap 27 discharges outside receiving opening 24 in a compensating chamber 28 that is delimited by a sealing diaphragm 29. Sealing diaphragm 29 is affixed to an outer wall of extension 23 on one side and to coupler head 26 on the other side, preferably by soldering or welding. Sealing diaphragm 29 is designed in the shape of a sleeve, preferably as a corrugated tube.

On its front-end, coupler head 26 is flange-mounted on a lid 30 delimiting valve interior 20 and soldered thereto. An electrical line 34 for triggering actuator 3 axially projects through lid 30. Moreover, there is a blind hole 35 in lid 30, which is connected to an axial fuel line 37 via a transverse bore 36. Blind hole 35, transverse bore 36, and fuel line 37 are provided to supply fuel to fuel injector 1.

Arranged between actuator head 22 and coupler head 26 is a coupler spring 38, which acts upon actuator head 22 counter to valve spring 9, so that in the rest position of actuator 3 a defined coupler gap 27 forms between piston 25 and actuator head 22 at the bottom of receiving bore 24. A cavity 40, which is connected to coupler gap 27 by way of a throttle opening 41 having a reduced flow-cross section, is located within piston 25. In a corresponding manner, cavity 40 is filled with the hydraulic fluid and forms a compensating chamber 42.

Fuel injector 1 has the following function: In its rest position, fuel injector 1 assumes the position shown in FIG. 1. When actuator 3 is activated it undergoes an expansion, which is transmitted to valve needle 6 via actuating element 17, so that valve-closure member 7 lifts off from valve-seat surface 12 and opens fuel injector 1. Since the linear expansion and subsequent shortening of actuator 3 occur very rapidly, coupler gap 27 remains largely filled with hydraulic fluid, so that actuator head 22 is able to be axially braced on coupler head 26 via the hydraulic fluid. Linear changes of actuator 3 as a result of thermal or mechanical loading are compensated by the hydraulic fluid in that it is able to escape to this compensating chamber 24 or to compensating chamber 42 or is able to enter from there.

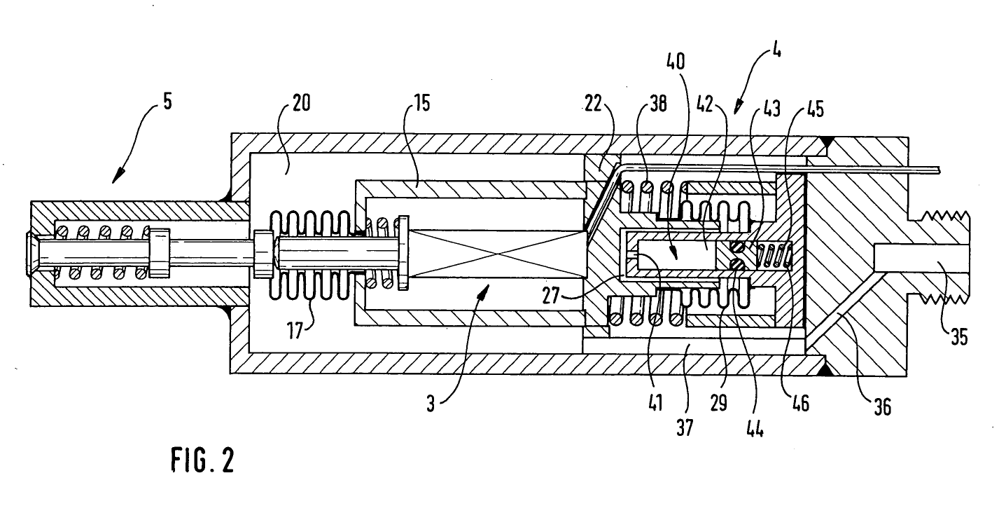

FIG. 2 shows a second exemplary embodiment of a fuel injector 1 according to the present invention. In this design, a compensating piston 43 is provided in cavity 40, which seals compensating chamber 42 from a spring cavity 45 via a sealing ring 44 at its outer periphery. Located in spring cavity 45 is an axial compression spring 46, which exerts pressure on the hydraulic fluid in compensating chamber 42 by way of piston 25. The volume of compensating chamber 42 may be varied with the aid of compensating piston 43.

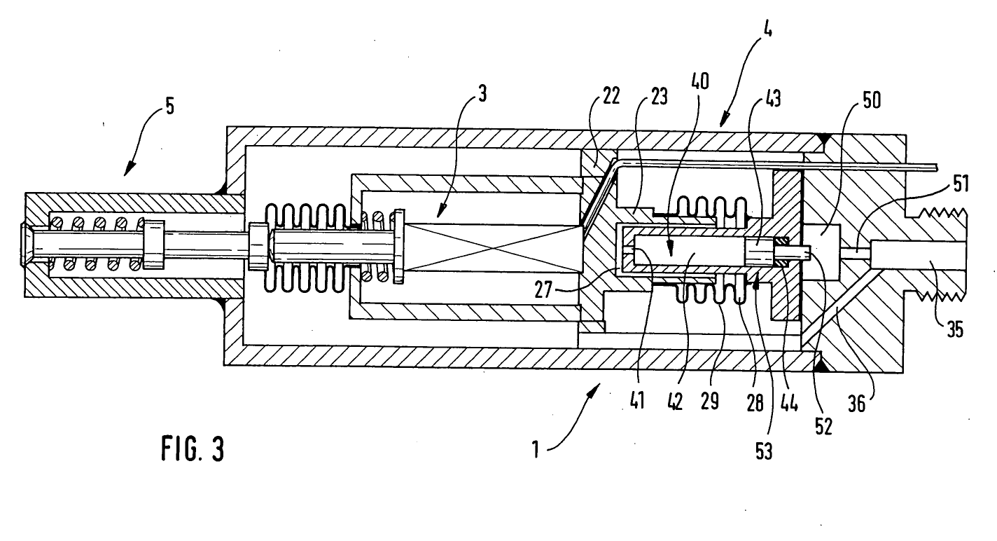

FIG. 3 shows a third exemplary embodiment of a fuel injector 1 according to the present invention. In this design, cavity 40 is open toward blind hole 35 carrying fuel. An interspace 50 adjoins cavity 40. Interspace 50 is in turn connected to blind hole 35 via a throttle line 51, so that fuel pressure prevails in interspace 50. On the fuel side, compensating piston 43 has a cylindrical nose 52 which is acted upon by the fuel pressure prevailing in interspace 50. In this design, compensating piston 43 is thus configured as differential piston 53. A compression spring 46 has been omitted. This design also includes no coupler spring 38.

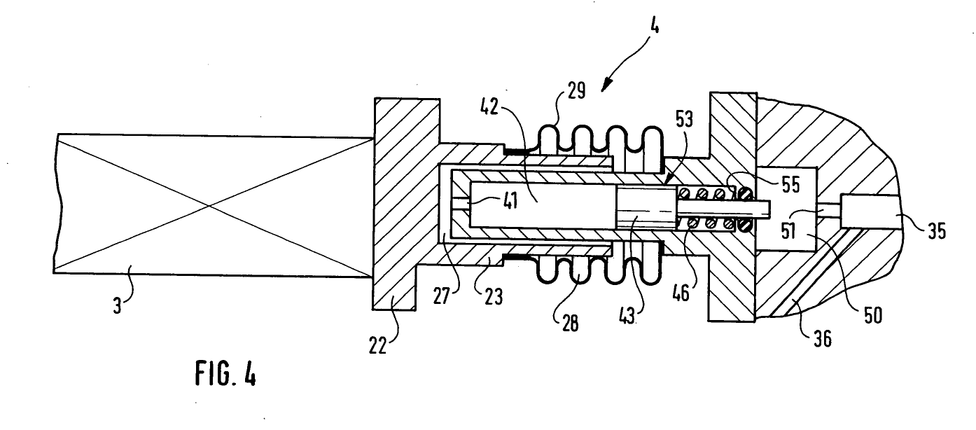

FIG. 4 shows a variant of the exemplary embodiment according to FIG. 3. Here, compensating piston 43 is once again configured as differential piston 53 on which not only the fuel pressure but also the force of compression spring 46 is acting in interspace 50, compression spring 46 being braced on a shoulder 55 within cavity 40.

The present invention is not restricted to the exemplary embodiments shown but also suitable for other designs of fuel injector 1, for instance for inwardly opening fuel injectors or fuel injectors having electrostrictive or magnetostrictive actuators.

1-11. (canceled)

12. A fuel injector comprising:
one of a piezoelectric, electrostricitve and magnetostrictive actuator;
a valve spring;
a valve-closure member;
a valve needle, which is in operative connection with the actuator and acted upon with a restoring force in a closing direction by the valve spring to actuate the valve-closure member; and
a hydraulic coupler which encompasses a piston engaging at least partially in a receiving opening and forming a coupler gap therewith that is filled with a hydraulic fluid, wherein a cavity is formed in the piston, the cavity being open toward the coupler gap and at least partially filled with the hydraulic fluid and forms a compensating chamber.

13. The fuel injector according to claim 12, wherein a throttle opening having a reduced flow-cross section is situated between the compensating chamber and the coupler gap.

14. The fuel injector according to claim 12, further comprising a sealing diaphragm, and wherein the coupler gap discharges outside the receiving opening in a further compensating chamber, which is likewise filled with hydraulic fluid and delimited by a sealing diaphragm.

15. The fuel injector according to claim 14, wherein the sealing diaphragm is formed by a corrugated tube.

16. The fuel injector according to claim 12, further comprising a compensating piston situated in the cavity.

17. The fuel injector according to claim 16, further comprising a compression spring for applying a force on the compensating piston.

18. The fuel injector according to claim 16, wherein the compensating piston is configured as a differential piston.

19. The fuel injector according to claim 18, wherein a fuel pressure acts on the differential piston on a side facing away from the compensating chamber.

20. The fuel injector according to claim 19, wherein the differential piston is additionally acted upon by a force of a compression spring.

21. The fuel injector according to claim 19, wherein the differential piston has a cylindrical nose which projects into an interspace filled with fuel.

22. The fuel injector according to claim 21, wherein the interspace is connected via a throttle line to a blind hole which is used to supply the fuel injector with fuel.
